(19) United States
(12) Patent Application Publication
(10) Pub. No.: US 2026/0140664 A1
(43) Pub. Date: May 21, 2026

(54) STORAGE CONTROLLER FOR MANAGING INVALID BLOCKS, STORAGE DEVICE INCLUDING THE STORAGE CONTROLLER, AND ELECTRONIC SYSTEM INCLUDING THE STORAGE DEVICE

(71) Applicant: SAMSUNG ELECTRONICS CO., LTD., SUWON-SI (KR)

(72) Inventors: YONGGIL SONG, Suwon-si (KR); SEOKHWAN KIM, Suwon-si (KR); Daejun Park, Suwon-si (KR)

(21) Appl. No.: 19/260,718

(22) Filed: Jul. 7, 2025

(30) Foreign Application Priority Data
Nov. 19, 2024 (KR) 10-2024-0165257

(51) Int. Cl. G06F 3/06

(52) U.S. Cl. CPC G06F 3/0659; G06F 3/0613; G06F 3/0679

(57) ABSTRACT

An electronic system includes a host configured to output an invalid area comparison command including invalid block information indicating a number of invalid host blocks containing invalid data among a plurality of host blocks included in a host memory, and a storage device, in response to the invalid area comparison command, configured to provide a request to the host indicating whether an unmap command provided by the host is necessary based on a result of comparing a number of invalid memory blocks stored in invalid data among a plurality of memory blocks included in a non-volatile memory device and the number of invalid host blocks.

### CROSS-REFERENCE TO RELATED APPLICATION

This U.S. application claims priority under 35 U.S.C. § 119 to Korean Patent Application No. 10-2024-0165257 filed with the Korean Intellectual Property Office on Nov. 19, 2024, the disclosure of which is incorporated by reference in its entirety herein.

### (a) Technical Field

The present disclosure is directed to a storage controller for managing invalid blocks, a storage device including the storage controller, and an electronic system including the storage device.

### (b) DISCUSSION OF RELATED ART

A storage device may include a non-volatile memory device that stores data and a storage controller that controls the non-volatile memory device. Since non-volatile memory devices do not allow overwriting, when the host changes or deletes data from host memory that has the same logical address as the logical address corresponding to data stored in the non-volatile memory device, the corresponding data in the non-volatile memory device may become invalid.

An unmap command is a command in a Solid-State Drive (SSD) that is used to deallocate logical blocks that are no longer in use, effectively informing the SSD that certain logical block addresses no longer contain valid data.

### SUMMARY

According to an embodiment, an electronic system includes a host configured to output an invalid area comparison command including invalid block information indicating a number of invalid host blocks containing invalid data among a plurality of host blocks included in a host memory, and a storage device, in response to the invalid area comparison command, configured to provide a request to the host indicating whether an unmap command provided by the host is necessary based on a result of comparing a number of invalid memory blocks containing invalid data among a plurality of memory blocks included in a non-volatile memory device and the number of invalid host blocks.

According to an embodiment, a storage device includes a non-volatile memory device including a valid area containing valid data and an invalid area containing invalid data, and a storage controller configured to receive an invalid area comparison command including invalid area information indicating a size of an invalid area of a host, and provide a request to the host indicating whether an unmap command is necessary based on a result of comparing the size of the invalid area of the host and a size of the invalid area of the non-volatile memory device.

According to an embodiment, a storage controller includes a memory interface configured to communicate with a non-volatile memory device including valid blocks and invalid blocks, a host interface configured to receive information indicating a number of invalid blocks of the host from the host, and an invalid area management module configured to request the host to provide an unmap command based on a result of comparing the number of invalid blocks of the host and a number of invalid blocks of the non-volatile memory device.

According to an embodiment, a storage device includes a non-volatile memory and a storage controller configured to receive a comparison command from a host and, in response, compare invalid block information associated with the host and the non-volatile memory to generate a comparison result. The storage controller is further configured to, in response to generating the comparison result, determine whether an unmap operation is required based on a threshold, and, in response to determining that an unmap operation is required, provide an unmap request to the host. The storage controller is further configured to, in response to providing the unmap request, receive an unmap command from the host and, in response, update mapping information to unmap specified addresses. The storage controller is further configured to, in response to unmapping the addresses, update the status of corresponding memory blocks in the non-volatile memory.

### BRIEF DESCRIPTION OF THE DRAWINGS

FIG. 1 is a drawing illustrating an electronic system including a storage device and a host according to an embodiment.

FIG. 2 is a drawing illustrating a storage device that performs operations corresponding to a flush command and an unmap command according to an embodiment.

FIG. 3 is a drawing illustrating a host that reorders an order for providing an unmap command to a storage device based on the generation of read commands and write commands according to an embodiment.

FIG. 4 is a drawing explaining a difference between an invalid area of a host and invalid area of a non-volatile memory device according to an embodiment.

FIG. 5 is a drawing illustrating a storage device that provides a host with a request indicating whether an unmap command is necessary based on a result of comparing invalid memory block information and invalid host block information according to an embodiment.

FIG. 6 is a drawing illustrating a host that reorders an order for providing an unmap command to a storage device based on an unmap requirement request according to an embodiment.

FIG. 7 is a drawing illustrating a storage device that unmaps an invalid logical address and a physical address corresponding to the invalid logical address in response to an unmap command according to an embodiment.

FIG. 8 is a drawing illustrating an electronic system for reordering an order of an unmap command and setting additional invalid areas based on a difference between invalid areas of a non-volatile memory device and invalid areas of a host according to an embodiment.

FIG. 9 is a drawing illustrating a host that reorders an order of unmap commands based on a result of comparing an invalid area of a non-volatile memory device with an invalid area of the host according to an embodiment.

FIG. 10 is a flowchart illustrating an operation of an electronic system according to an embodiment.

FIG. 11 is a drawing for illustrating a non-volatile memory device according to an embodiment.

### DETAILED DESCRIPTION

In the following detailed description, certain embodiments of the present disclosure have been shown and described by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

In addition, unless explicitly described to the contrary, the word “comprise”, and variations such as “comprises” or “comprising”, will be understood to imply the inclusion of stated elements but not the exclusion of any other elements.

Embodiments of the disclosure relate to a storage controller for managing invalid blocks in a non-volatile memory device, such as an SSD or (Universal Flash Storage) storage system. These embodiments may address inefficiencies in handling unmap commands, which are used to free up storage space occupied by invalid data. Traditional storage devices rely on the host to issue unmap commands, but delays in executing these commands can lead to discrepancies between the amount of invalid data tracked by the host and the actual invalid data in the storage device. This mismatch can result in unnecessary write operations, increased write amplification, and suboptimal storage performance.

The storage controller, according an embodiment, evaluates the number of invalid blocks in the host and the storage device when a predefined condition is met. For example, if the difference exceeds a predefined threshold, the controller requests the host to issue an unmap command, ensuring that stale data is promptly removed and memory management is optimized. This selective approach prevents excessive unmap operations, reducing system overhead while maintaining efficient memory usage.

Additionally, an embodiment enables reordering of unmap commands based on system conditions. Instead of executing unmap commands immediately, the host can prioritize more important read and write operations before sending the unmap request. This may increase overall storage performance by preventing unmap operations from blocking high-priority commands. Once the unmap command is executed, the storage device efficiently unmaps invalid logical addresses, updates metadata, and prevents unnecessary data migration during garbage collection, further optimizing memory management.

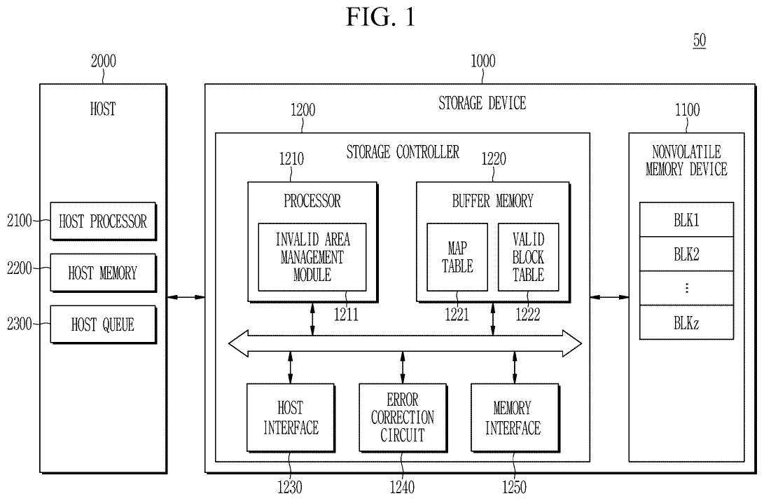

FIG. 1 is a drawing illustrating an electronic system including a storage device and a host according to an embodiment.

Referring to FIG. 1, an electronic system 50 may include a storage device 1000 and a host 2000 (e.g., a host device).

The storage device 1000 may be a device that stores data under the control of the host 2000. In an embodiment, the storage device 1000 may be manufactured in the form of a solid state drive (SSD) or a universal flash storage (UFS).

In an embodiment, the storage device 1000 includes a non-volatile memory device 1100 and a storage controller 1200.

In an embodiment, the non-volatile memory device 1100 stores data. The non-volatile memory device 1100 may operate in response to a control of the storage controller 1200. In an embodiment, the non-volatile memory device 1100 is NAND flash memory. In an embodiment, a non-volatile memory device 1100 includes a plurality of memory blocks BLK1 to BLKz. Each of the plurality of memory blocks BLK1 to BLKz may include a plurality of memory cells that store data. In an embodiment, the plurality of memory blocks BLK1 to BLKz may include valid memory blocks and invalid memory blocks. In an embodiment, the valid memory blocks may be memory blocks in which valid data is stored. In an embodiment, the invalid memory blocks are memory blocks in which invalid data is stored.

In an embodiment, the non-volatile memory device 1100 receives a command and an address from the storage controller 1200 and performs an operation indicated by the command for an area selected by the address. In an embodiment, the non-volatile memory device 1100 performs a program operation (write operation) to store data in an area selected by an address, a read operation to read data, or an erase operation to delete data.

The storage controller 1200 may control an overall operation of the storage device 1000.

In an embodiment, the storage controller 1200 executes firmware when power is applied to the storage device 1000. The firmware may include a host interface layer that controls communication with the host 2000, a flash translation layer that controls communication between the host 2000 and the non-volatile memory device 1100, and a memory interface layer that controls communication with the non-volatile memory device 1100. In an embodiment, the flash translation layer translates a logical address of the host 2000 into a physical address of the non-volatile memory device 1100.

In an embodiment, the storage controller 1200 controls the non-volatile memory device 1100 to perform the write operation, the read operation, or the erase operation, according to a request of the host 2000. The request may be a command issued by the host 2000. The storage controller 1200 may provide a write command, an address, and data to the non-volatile memory device 1100 during the write operation. The storage controller 1200 may provide a read command and an address to the non-volatile memory device 1100 during the read operation. The storage controller 1200 may provide an erase command and an address to the non-volatile memory device 1100 during the erase operation.

In an embodiment, the storage controller 1200 includes a processor 1210, a buffer memory 1220, a host interface 1230 (e.g., a first interface circuit), an error correction circuit 1240, and a memory interface 1250 (e.g., a second interface circuit).

In an embodiment, the processor 1210 controls an overall operation of the storage controller 1200. The processor 1210 may control the write operation according to the write command of the host 2000 and the read operation according to the read command of the host 2000.

In an embodiment, the processor 1210 includes an invalid area management module 1211. The invalid area management module 1211 may be a logic circuit or a program stored in a memory of the processor 1210 and executed by the processor 1210. In an embodiment, the invalid area management module 1211 manages invalid memory blocks and valid memory blocks among a plurality of memory blocks BLK1 to BLKz of the non-volatile memory device 1100.

In an embodiment, the invalid area management module 1211, in response to an unmap command received from the host 2000, unmaps an invalid logical address included in the unmap command and a physical address corresponding to the invalid logical address. For example, the invalid area management module 1211 may cause the storage controller 1200 to update its mapping table to remove the association between a logical block address indicated by the unmap command and a corresponding physical address in the nonvolatile memory device 1100. Once the logical block address is unmapped, the storage controller 1200 may also mark the physical address corresponding to the logical block address as invalid,

In an embodiment, the invalid area management module 1211, in response to receiving the unmap command from the host 2000, sets a memory block corresponding to the invalid logical address among the plurality of memory blocks BLK1 to BLKz as an invalid memory block.

In an embodiment, the invalid area management module 1211, in response to receiving an invalid area comparison command from the host 2000, provides a request to the host 2000 indicating whether the unmap command is necessary based on a result of comparing a number of invalid host blocks in which invalid data is stored among a plurality of host blocks included in a host memory 2200 and a number of invalid memory blocks in which invalid data is stored among the plurality of memory blocks BLK1 to BLKz of the non-volatile memory device 1100.

In an embodiment, when a difference between the number of invalid host blocks of the host memory 2200 and the number of invalid memory blocks of the non-volatile memory device 1100 is greater than a threshold number, the invalid area management module 1211 provides an unmap requirement request indicating necessity of the unmap command to the host 2000 as a response to the invalid area comparison command.

In an embodiment, the invalid area management module 1211 determines a number of memory blocks to be invalidated among the plurality of memory blocks BLK1 to BLKz based on the difference between the number of invalid host blocks of the host memory 2200 and the number of invalid memory blocks of the non-volatile memory device 1100, and provides the unmap requirement request including information regarding the number of memory blocks to be invalidated to the host 2000.

In an embodiment, when the difference between the number of invalid host blocks of the host memory 2200 and the number of invalid memory blocks of the non-volatile memory device 1100 is less than the threshold number, the invalid area management module 1211 provides an unmap unnecessary request indicating the unnecessity of the unmap command, to the host 2000 as a response to the invalid area comparison command.

In an embodiment, the buffer memory 1220 is used as a cache memory or an operating memory of the storage controller 1200.

In an embodiment, the buffer memory 1220 temporarily stores data provided from the host 2000 or temporarily stores data read from the non-volatile memory device 1100. In an embodiment, the buffer memory 1220 is a dynamic random access memory (DRAM) or a static random access memory (SRAM). In an embodiment, the buffer memory 1220 may be located within the storage controller 1200 or may be located outside the storage controller 1200.

In an embodiment, the buffer memory 1220 stores a map table 1221 and a valid block table 1222.

In an embodiment, the map table 1221 is a table representing a mapping relationship between a logical address (e.g., a logical block address) of the host 2000 and a physical address of the non-volatile memory device 1100. In an embodiment, the physical address may be an address of a memory block BLK. In an embodiment, the map table 1221 is updated by the invalid area management module 1211. In an embodiment, the mapping relationship between the logical address and the physical address may be released by the invalid area management module 1211. For example, the release may remove the association between the logical address and the physical address.

In an embodiment, the valid block table 1222 is a table indicating whether one or more of the plurality of memory blocks BLK1 to BLKz are valid memory blocks storing valid data or invalid memory blocks storing invalid data. In an embodiment, the valid block table 1222 is updated by the invalid area management module 1211. In an embodiment, the invalid area management module 1211 sets some memory blocks among the plurality of memory blocks BLK1 to BLKz as invalid memory blocks based on the valid block table 1222.

In an embodiment, the host interface 1230 communicates with the host 2000. The host interface 1230 may receive commands or data from the host 2000, or provide a response of command or data to the host 2000.

In an embodiment, the error correction circuit 1240 performs an encoding operation to generate parity data for data received from the host 2000. The encoded data may be provided to the non-volatile memory device 1100 via the memory interface 1250. The error correction circuit 1240 may perform an error correction operation on data read from the non-volatile memory device 1100. The error correction circuit 1240 may perform the error correction operation to correct error bits included in data read from the non-volatile memory device 1100 to generate error-corrected data. The error correction circuit 1240 may provide the error-corrected data to the host 2000 through the host interface 1230.

In an embodiment, the memory interface 1250 may communicate with the non-volatile memory device 1100. The memory interface 1250 may provide commands or data to the non-volatile memory device 1100, or receive data from the non-volatile memory device 1100.

In an embodiment, the host 2000 includes a host processor 2100, the host memory 2200, and a host queue 2300. The host queue 2300 may be a memory buffer or pointers to a memory buffer as an example.

In an embodiment, the host processor 2100 controls an overall operation of the host 2000. In an embodiment, the host processor 2100 generates a write command requesting to store data in the storage device 1000 and a read command requesting data stored in the storage device 1000.

In an embodiment, the host memory 2200 stores data. In an embodiment, the host memory 2200 is a volatile memory. In an embodiment, the host memory 2200 includes a plurality of host blocks. The plurality of host blocks may include valid host blocks storing valid data and invalid host blocks storing invalid data.

In an embodiment, the host queue 2300 stores a plurality of commands generated by the host processor 2100. In an embodiment, the host queue 2300 provides the plurality of commands to the storage device 1000 in an order in which the plurality of commands are stored. For example, the commands in the host queue 2300 are sent to the storage device 1000 in the same sequence in which they were placed in the host queue 2300.

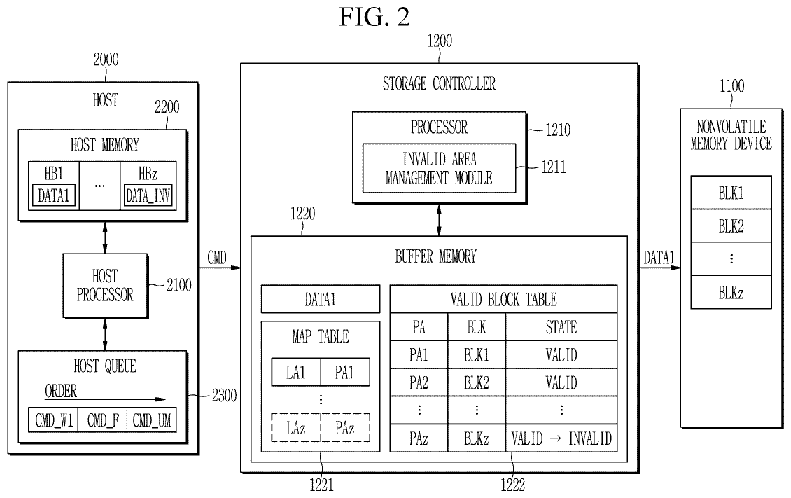

FIG. 2 is a drawing illustrating a storage device that performs operations corresponding to a flush command and an unmap command according to an embodiment.

Referring to FIG. 2, the host processor 2100 may generate a first write command CMD_W1, a flush command CMD_F, and an unmap command CMD_UM. In an embodiment, the host processor 2100 provides the first write command CMD_W1, the flush command CMD_F, and the unmap command CMD_UM to the host queue 2300. In an embodiment, the host queue 2300 sequentially stores the first write command CMD_W1, the flush command CMD_F, and the unmap command CMD_UM.

In an embodiment, the host queue 2300 provides the first write command CMD_W1, the flush command CMD_F, and the unmap command CMD_UM to the storage controller 1200 in an order in which the first write command CMD_W1, the flush command CMD_F, and the unmap command CMD_UM are stored. In an embodiment, the host queue 2300 sequentially provides the first write command CMD_W1, the flush command CMD_F, and the unmap command CMD_UM to the storage controller 1200. For example, these commands are sent to the storage controller 1200 in the exact sequence they were placed in the host queue 2300, without reordering by the host 2000.

In an embodiment, the host processor 2100 controls the host queue 2300 to provide the first write command CMD_W1 and first data DATA1 stored in a first host block HB1 among a plurality of host blocks HB1 to HBz of the host memory 2200 to the storage controller 1200.

In an embodiment, the processor 1210 stores the first data DATA1 in the buffer memory 1220 in response to the first write command CMD_W1.

In an embodiment, the host processor 2100 controls the host queue 2300 to provide the first write command CMD_W1 to the storage controller 1200 and then provide the flush command CMD_F to the storage controller 1200.

In an embodiment, the storage controller 1200 controls the non-volatile memory device 1100 to perform a flush operation to store the first data DATA1 stored in the buffer memory 1220 in one of the plurality of memory blocks BLK1 to BLKz of the non-volatile memory device 1100 in response to the flush command CMD_F.

In an embodiment, the host processor 2100 controls the host queue 2300 to provide the flush command CMD_F to the storage controller 1200 and then provide the unmap command CMD_UM to the storage controller 1200.

In an embodiment, the unmap command CMD_UM includes information regarding an invalid logical address that is a target of the unmap. In an embodiment, the invalid logical address is an address of an invalid host block in which invalid data is stored.

In an embodiment, when data stored in a z-th host block HBz among the plurality of host blocks HB1 to HBz is invalid data DATA_INV, the invalid logical address to be unmapped may be the z-th logical address LAz corresponding to the z-th host block HBz.

In an embodiment, the host processor 2100 controls the host queue 2300 to provide the unmap command CMD_UM including information regarding the z-th logical address LAz corresponding to the z-th host block HBz to the storage controller 1200.

In an embodiment, the invalid area management module 1211, in response to an unmap command (CMD_UM), unmaps the invalid logical address and a physical address corresponding to the invalid logical address.

In an embodiment, the invalid area management module 1211 accesses the map table 1221 to retrieve mapping information, unmaps the z-th logical address LAz included in the unmap command CMD_UM and a z-th physical address PAz corresponding to the z-th logical address LAz, updates the mapping information based on the unmapping, and stores the updated mapping information in the map table 1221 in the buffer memory 1220.

In an embodiment, the invalid area management module 1211, in response to an unmap command (CMD_UM) specifying an invalid logical address, sets a memory block of a physical address corresponding to the invalid logical address among the plurality of memory blocks BLK1 to BLKz as an invalid memory block. In an embodiment, the z-th physical address PAz corresponding to the z-th logical address LAz included in the unmap command CMD_UM is an address of the z-th memory block BLKz.

In an embodiment, the invalid area management module 1211 reads the valid block table 1222 to determine whether the z-th memory block BLKz corresponding to the z-th physical address Paz is valid. Based on the result, the module 1211 updates the valid block table 1222 by setting the z-th memory block BLKz as an invalid memory block INVALID, and stores the updated valid block table 1222 in the buffer memory 1220.

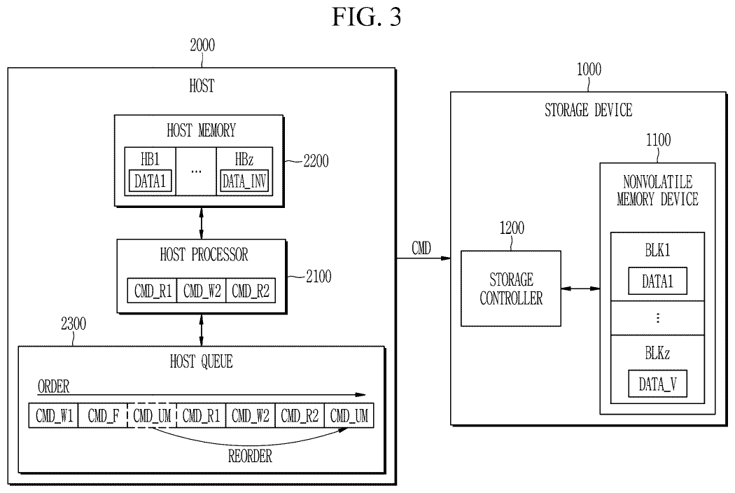

FIG. 3 is a drawing illustrating a host that reorders an order for providing an unmap command to a storage device based on the generation of read commands and write commands according to an embodiment.

Referring to FIG. 3, the host processor 2100 may generate the first write command CMD_W1, the flush command CMD_F, and the unmap command CMD_UM, and provide the first write command CMD_W1, the flush command CMD_F, and the unmap command CMD_UM to the host queue 2300.

In an embodiment, the host processor 2100 generates the first write command CMD_W1, the flush command CMD_F, and the unmap command CMD_UM, and then generates a first read command CMD_R1, a second write command CMD_W2, and a second read command CMD_R2, and provides the first read command CMD_R1, the second write command CMD_W2, and the second read command CMD_R2 to the host queue 2300.

In an embodiment, the host queue 2300 stores a plurality of commands in an order of the first write command CMD_W1, the flush command CMD_F, the unmap command CMD_UM, the first read command CMD_R1, the second write command CMD_W2, and the second read command CMD_R2.

In an embodiment, the plurality of commands stored in the host queue 2300 are provided to the storage device 1000 in the following order: the first write command CMD_W1, the flush command CMD_F, the unmap command CMD_UM, the first read command CMD_R1, the second write command CMD_W2, and the second read command CMD_R2.

In an embodiment, the host processor 2100 reorders an order in which the unmap command CMD_UM is provided to the storage device 1000 when a number of read commands and write commands stored in the host queue 2300 is greater than a preset number.

In an embodiment, the host processor 2100 provides the first read command CMD_R1, the second write command CMD_W2, and the second read command CMD_R2 to the host queue 2300, and then reorders the order of the unmap command CMD_UM to provide the first read command CMD_R1, the second write command CMD_W2, and the second read command CMD_R2 to the storage device 1000 prior to the unmap command CMD_UM.

In an embodiment, the host processor 2100 controls the host queue 2300 to provide the plurality of commands to the storage device 1000 in an order of the first write command CMD_W1, the flush command CMD_F, the first read command CMD_R1, the second write command CMD_W2, the second read command CMD_R2, and the unmap command CMD_UM after reordering the order of the unmap command CMD_UM.

In an embodiment, the unmap command CMD_UM includes information regarding the z-th logical address LAz corresponding to the z-th host block HBz in which the invalid data DATA_INV is stored.

In an embodiment, when the order of the unmap command CMD_UM is reordered so that the first read command CMD_R1, the second write command CMD_W2, and the second read command CMD_R2 are provided to the storage device 1000 prior to the unmap command CMD_UM, data stored in the z-th host block HBz corresponding to the z-th logical address LAz is invalid data DATA_INV. However, the storage controller 1200 maintains sets the z-th memory block BLKz corresponding to the z-th logical address LAz as a valid memory block containing valid data DATA_V until it receives the unmap command CMD_UM from the host 2000.

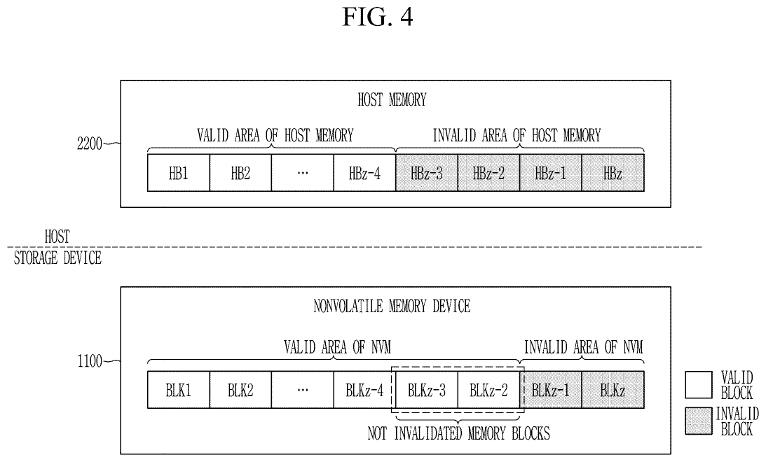

FIG. 4 is a drawing for explaining a difference between an invalid area of a host and invalid area of a non-volatile memory device according to an embodiment.

Referring to FIG. 4, the host memory 2200 may include the plurality of host blocks HB1 to HBz. In an embodiment, the plurality of host blocks HB1 to HBz include valid host blocks containing valid data and invalid host blocks containing invalid data. In an embodiment, the first to z-4th host blocks HB1 to HBz-4 are valid host blocks containing valid data. In the embodiment, the first to z-4th host blocks HB1 to HBz-z correspond to valid areas of the host memory 2200.

In an embodiment, the z-3th to z-th host blocks HBz-3 to HBz are invalid host blocks containing invalid data. In the embodiment, the z-3th to z-th host blocks HBz-3 to HBz correspond to invalid areas of the host memory 2200.

In an embodiment, the non-volatile memory device 1100 includes the plurality of memory blocks BLK1 to BLKz. The plurality of memory blocks BLK1 to BLKz may include valid memory blocks containing valid data and invalid memory blocks containing invalid data.

In an embodiment, the first to z-2th memory blocks BLK1 to BLKz-2 are valid memory blocks containing valid data. In the embodiment, the first to z-2th memory blocks BLK1 to BLKz-2 correspond to valid areas of the non-volatile memory device 1100.

In an embodiment, the z-1 and z-th memory blocks BLKz-1, BLKz are invalid memory blocks containing invalid data. In the embodiment, the z-1 and z-th memory blocks BLKz-1, BLKz correspond to invalid areas of the non-volatile memory device 1100.

In an embodiment, when the host 2000 provides write commands and read commands to the storage device 1000 prior to the unmap command CMD_UM, a difference may occur between the number of invalid host blocks of the host memory 2200 and the number of invalid memory blocks of the non-volatile memory device 1100.

For example, the number of invalid host blocks may be four, as the z-3th to z-th host blocks HBz-3 to HBz, and the number of invalid memory blocks may be two, as the z-1 and z-th memory blocks BLKz-1, BLKz.

In the embodiment, the z-3th and z-2th host blocks HBz-3, HBz-2 are invalid host blocks storing invalid data, but the z-3th and z-2th memory blocks BLKz-3, BLKz-2 are not invalidated until the unmap command CMD_UM is received. In an embodiment, the z-3th and z-2th memory blocks BLKz-3, BLKz-2 remain set as valid memory blocks until the unmap command CMD_UM is received.

In an embodiment, the storage device 1000 sets non-invalidated memory blocks among the plurality of memory blocks BLK1˜BLKz as valid memory blocks before the unmap command CMD_UM is received, and copies data stored in the non-invalidated memory blocks to other memory blocks while performing an internal operation such as garbage collection, wear leveling, or read reclaim. For example, the storage device 1000 marks memory blocks that have not been invalidated as valid before receiving the unmap command CMD_UM.

In the embodiment, the z-3th and z-2th host blocks HBz-3, HBz-2 are invalid host blocks, but the storage device 1000 sets the z-3th and z-2th memory blocks BLKz-3, BLKz-2 as valid memory blocks until the unmap command CMD_UM is received, so that data stored in the z-3th and z-2th memory blocks BLKz-3, BLKz-2 may also be copied to other memory blocks while performing the internal operation.

In the embodiment, since the z-3th and z-2th memory blocks BLKz-3, BLKz-2 are memory blocks that are set as invalid memory blocks when the unmap command CMD_UM is received, when data stored in the z-3th and z-2th memory blocks BLKz-3, BLKz-2 is copied to other memory blocks while performing internal operations, write amplification factor WAF may increase.

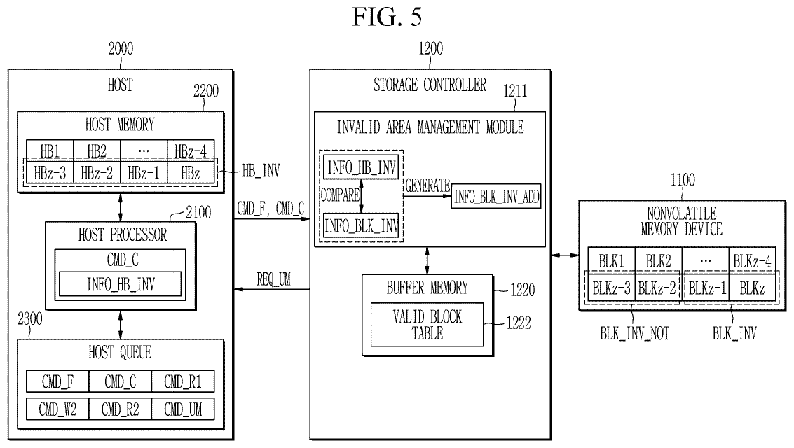

FIG. 5 is a drawing illustrating a storage device that provides a host with a request indicating whether an unmap command is necessary based on a result of comparing invalid memory block information and invalid host block information according to an embodiment.

Referring to FIG. 5, the host processor 2100 may generate the flush command CMD_F and an invalid area compare command CMD_C.

In an embodiment, the invalid area comparison command CMD_C is a command that instructs a comparison of the number of invalid host blocks HB_INV of the host memory 2200 and the number of invalid memory blocks BLK_INV of the non-volatile memory device 1100.

In an embodiment, the host processor 2100 may provide the flush command CMD_F and the invalid area compare command CMD_C to the host queue 2300.

In an embodiment, the host processor 2100 generates invalid host block information INFO_HB_INV and generates the invalid area comparison command CMD_C including the invalid host block information INFO_HB_INV.

In an embodiment, the invalid host block information INFO_HB_INV includes information regarding the number of invalid host blocks HB_INV. In an embodiment, the invalid host blocks HB_INV are the z-3th to z-th host blocks HBz-3 to HBz. For example, the number of invalid host blocks HB_INV may be four, but is not limited thereto.

In an embodiment, the host processor 2100 controls the host queue 2300 to sequentially provide the flush command CMD_F and the invalid area compare command CMD_C to the storage controller 1200.

In an embodiment, the storage controller 1200 controls the non-volatile memory device 1100 to store data stored in the buffer memory 1220 in the non-volatile memory device 1100 in response to the flush command CMD_F.

In an embodiment, the invalid area management module 1211 generates invalid memory block information INFO_BLK_INV in response to the invalid area comparison command CMD_C.

In an embodiment, the invalid memory block information INFO_BLK_INV includes information regarding the number of invalid memory blocks BLK_INV. For example, the invalid memory blocks BLK_INV may be the z-1 and z-th memory blocks BLKz-1, BLKz. For example, the number of invalid memory blocks BLK_INV may be two, but is not limited thereto.

In an embodiment, the invalid area management module 1211 compares the invalid host block information INFO_HB_INV and the invalid memory block information INFO_BLK_INV in response to the invalid area comparison command CMD_C.

In an embodiment, the invalid area management module 1211 provides a request REQ_UM indicating whether the unmap command CMD_UM is necessary to the host 2000 as a response to the invalid area comparison command CMD_C based on a result of comparing the number of invalid host blocks HB_INV included in the invalid host block information INFO_HB_INV and the number of invalid memory blocks BLK_INV included in the invalid memory block information INFO_BLK_INV.

In an embodiment, when a difference between the number of invalid host blocks HB_INV and the number of invalid memory blocks BLK_INV is greater than a threshold number, the invalid area management module 1211 provides an unmap requirement request REQ_UM indicating that the unmap command CMD_UM is required to the host 2000 as the response to the invalid area comparison command CMD_C.

In an embodiment, when the difference between the number of invalid host blocks HB_INV and the number of invalid memory blocks BLK_INV is less than the threshold number, the invalid area management module 1211 provides an unmap unnecessary request REQ_UM, indicating that the unmap command CMD_UM is unnecessary, to the host 2000 as the response to the invalid area comparison command CMD_C.

In an embodiment, when the difference between the number of invalid host blocks HB_INV and the number of invalid memory blocks BLK_INV is greater than the threshold number, the invalid area management module 1211 determines a number of memory blocks to be invalidated among the plurality of memory blocks BLK1 to BLKz based on the difference between the number of invalid host blocks HB_INV and the number of invalid memory blocks BLK_INV. The invalid area management module 1211 may include a comparator circuit or have access to a comparator circuit of the storage controller to determine the difference.

In an embodiment, memory blocks to be invalidated may be some or all of the valid memory blocks of the non-volatile memory device 1100. In an embodiment, the memory blocks to be invalidated may be some or all of the non-invalidated memory blocks BLK_INV_NOT.

In an embodiment, the invalid area management module 1211 determines the difference between the number of invalid host blocks HB_INV and the number of invalid memory blocks BLK_INV as the number of memory blocks to be invalidated. For example, the invalid area management module 1211 may determine the number of memory blocks to be invalidated as 2 when the number of invalid host blocks HB_INV is 4 and the number of invalid memory blocks BLK_INV is 2.

In an embodiment, the invalid area management module 1211 determines a difference between a threshold number and a number corresponding to the difference between the number of invalid host blocks HB_INV and the number of invalid memory blocks BLK_INV and the threshold number as the number of memory blocks to be invalidated. For example, when the number of invalid host blocks HB_INV is 4, the number of invalid memory blocks BLK_INV is 2, and the threshold number is 1, the invalid area management module 1211 may determine the number of memory blocks to be invalidated as 2, which is the difference between the number of invalid host blocks HB_INV and the number of invalid memory blocks BLK_INV, and 1, which corresponds to the difference of 1, the threshold number.

In an embodiment, the invalid area management module 1211 generates information on memory blocks to be invalidated INFO_BLK_INV_ADD based on the difference between the number of invalid host blocks HB_INV and the number of invalid memory blocks. In an embodiment, the information on memory blocks to be invalidated INFO_BLK_INV_ADD includes information regarding the number of memory blocks to be invalidated.

In an embodiment, the invalid area management module 1211 provides the unmap requirement request REQ_UM including the information on memory blocks to be invalidated INFO_BLK_INV_ADD to the host 2000 as a response to the invalid area comparison command CMD_C.

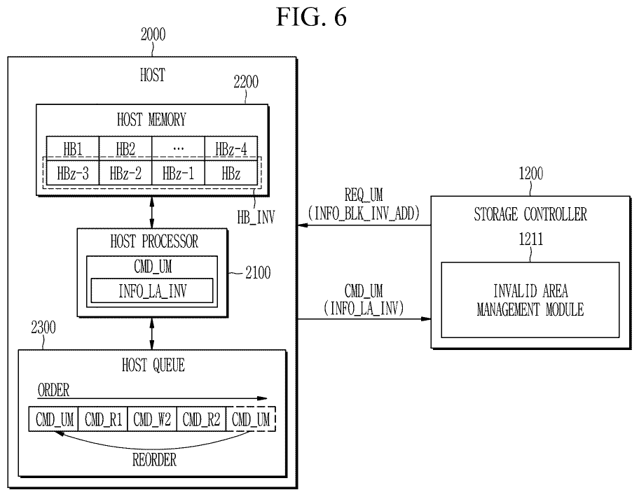

FIG. 6 is a drawing illustrating a host that reorders an order for providing an unmap command to a storage device based on an unmap requirement request according to an embodiment.

Referring to FIG. 6, the invalid area management module 1211 may, in response to an invalid area comparison command CMD_C, provide the request REQ_UM regarding the necessity of an unmap command to the host 2000 based on the result of comparing the number of invalid host blocks HB_INV with the number of invalid memory blocks BLK_INV.

In an embodiment, when the difference between the number of invalid host blocks HB_INV and the number of invalid memory blocks BLK_INV is greater than a threshold number, the invalid area management module 1211 may provide the unmap requirement request REQ_UM including the information on memory blocks to be invalidated INFO_BLK_INV_ADD regarding the number of memory blocks to be invalidated to the host 2000.

In an embodiment, the host processor 2100 receives the unmap requirement request REQ_UM and controls the host queue 2300 to reorder the order in which the unmap command CMD_UM is provided to the storage controller 1200 based on the unmap requirement request REQ_UM.

In an embodiment, before the order in which the unmap command CMD_UM is provided to the storage controller 1200 is reordered, the host queue 2300 may store a plurality of commands in an order of the first read command CMD_R1, the second write command CMD_W2, the second read command CMD_R2, and the unmap command CMD_UM.

In an embodiment, when the order in which the unmap command CMD_UM is provided to the storage controller 1200 is reordered, the host queue 2300 may store the plurality of commands in an order of the unmap command CMD_UM, the first read command CMD_R1, the second write command CMD_W2, and the second read command CMD_R2.

In an embodiment, the host processor 2100 reorders the order of the unmap command CMD_UM to provide the unmap command CMD_UM to the storage controller 1200 prior to the first read command CMD_R1, the second write command CMD_W2, and the second read command CMD_R2 based on the unmap requirement request REQ_UM. In an embodiment, the host queue 2300 reorders the order of the unmap command CMD_UM and then provides the plurality of commands to the storage controller 1200 in the order of the unmap command CMD_UM, the first read command CMD_R1, the second write command CMD_W2, and the second read command CMD_R2.

In an embodiment, the host processor 2100 determines a number of invalid logical addresses to be unmapped based on the number of memory blocks to be invalidated included in the information on memory blocks to be invalidated INFO_BLK_INV_ADD.

In an embodiment, the host processor 2100 controls the host queue 2300 to generate invalid logical address information INFO_LA_INV including invalid logical addresses corresponding to the number of invalid logical addresses, and provides the unmap command CMD_UM including the invalid logical address information INFO_LA_INV to the storage controller 1200.

For example, when the number of memory blocks to be invalidated is two, the host processor 2100 may determine the number of invalid logical addresses to be two, and may generate the invalid logical address information INFO_LA_INV including the invalid logical addresses corresponding to the two. For example, when the number of memory blocks to be invalidated is 2, the host processor 2100 may generate the invalid logical address information INFO_LA_INV including a z-3th logical address corresponding to a z-3th host block HBz-3 and a z-2th logical address corresponding to a z-2th host block HBz-2.

For example, when the number of memory blocks to be invalidated is 1, the host processor 2100 may determine the number of invalid logical addresses to be 1, and may generate the invalid logical address information INFO_LA_INV including the invalid logical address corresponding to 1. For example, when the number of memory blocks to be invalidated is 1, the host processor 2100 may generate the invalid logical address information INFO_LA_INV including the z-2th logical address corresponding to the z-2 host block HBz-2.

In an embodiment, the invalid area management module 1211 provides the unmap unnecessary request REQ_UM to the host 2000 when the difference between the number of invalid host blocks HB_INV and the number of invalid memory blocks BLK_INV is less than the threshold number.

In an embodiment, the host processor 2100 does not reorder the order in which the unmap command CMD_UM is provided to the storage controller 1200 when the unmap unnecessary request REQ_UM is received from the storage controller 1200.

In an embodiment, when the order in which the unmap command CMD_UM is provided to the storage controller 1200 is not reordered, the host queue 2300 stores the plurality of commands in the order of the first read command CMD_R1, the second write command CMD_W2, the second read command CMD_R2, and the unmap command CMD_UM.

In an embodiment, when the order in which the unmap command CMD_UM is provided to the storage controller 1200 is not reordered, the host queue 2300 provides the plurality of commands to the storage controller 1200 in the order of the first read command CMD_R1, the second write command CMD_W2, the second read command CMD_R2, and the unmap command CMD_UM.

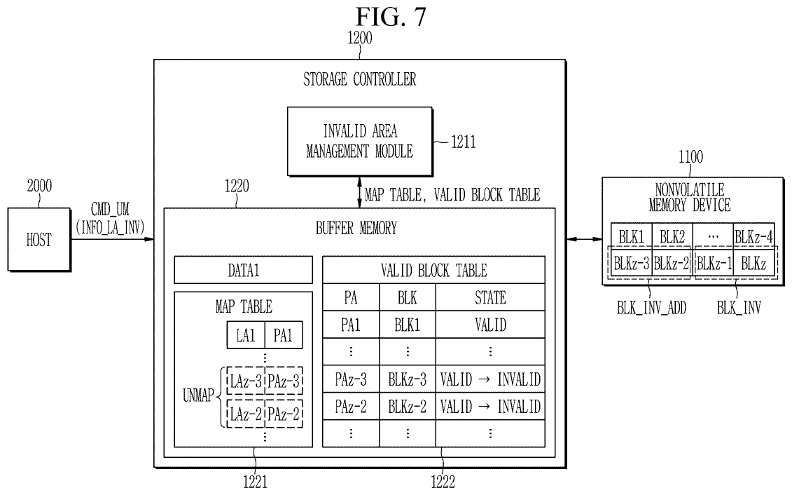

FIG. 7 is a drawing illustrating a storage device that unmaps an invalid logical address and a physical address corresponding to the invalid logical address in response to an unmap command according to an embodiment.

Referring to FIG. 7, the host 2000 may reorder the order in which the unmap command CMD_UM is provided to the storage controller 1200 based on the unmap requirement request REQ_UM received from the storage controller 1200, and may provide the unmap command CMD_UM including the invalid logical address information INFO_LA_INV corresponding to invalid host blocks to the storage controller 1200 prior to other write commands and other read commands.

In an embodiment, in response to the unmap command CMD_UM, the invalid area management module 1211 unmaps the invalid logical addresses included in the unmap command CMD_UM and physical addresses corresponding to the invalid logical addresses.

In an embodiment, the invalid area management module 1211 may receive the unmap command CMD_UM including z-3th and z-2th logical addresses LAz-3, LAz-2 corresponding to the invalid logical addresses from the host 2000.

In an embodiment, the invalid area management module 1211 may read the map table 1221 from the buffer memory 1220 to retrieve mapping information for logical addresses. Based on the retrieved mapping information, the invalid area management module 1211 may identify the z-3th logical address LAz-3 and its corresponding z-3th physical address PAz-3, as well as the z-2th logical address LAz-2 and its corresponding z-2th physical address PAz-2. The invalid area management module 1211 may then unmap the identified logical addresses and their corresponding physical addresses, and update the map table 1221 accordingly before storing it back in the buffer memory 1220.

In an embodiment, the invalid area management module 1211 sets memory blocks of physical addresses corresponding to invalid logical addresses as invalid memory blocks in response to the unmap command CMD_UM.

In an embodiment, the invalid area management module 1211 reads the valid block table 1222 from the buffer memory 1220 in response to the unmap command CMD_UM, which includes the z-3th and z-2th logical addresses LAz-3 and LAz-2. Based on the retrieved valid block table 1222, the invalid area management module 1211 may identify the z-3th memory block BLKz-3 corresponding to the z-3th physical address PAz-3 as well as the z-2th memory block BLKz-2 corresponding to the z-2th physical address PAz-2. Using this information, the invalid area management module 1211 may update the valid block table 1222 by marking BLKz-3 and BLKz-2 as invalid memory blocks INVALID, before storing the updated valid block table 1222 back in the buffer memory 1220.

In an embodiment, the z-3th and z-2th memory blocks BLKz-3 and BLKz-2 may be set as additional invalid memory blocks BLK_INV_ADD according to the unmap command CMD_UM.

In an embodiment, data stored in the z-1th and z-th memory blocks BLKz-1 and BLKz corresponding to the invalid memory block BLK_INV and data stored in the z-3th and z-2th memory blocks BLKz-3 and BLKz-2 corresponding to the additional invalid memory block BLK_INV_ADD may be invalid data.

In an embodiment, the storage controller 1200 controls the non-volatile memory device 1100 to erase data stored in the invalid memory block BLK_INV and the additional invalid memory block BLK_INV_ADD while performing garbage collection.

In an embodiment, the storage controller 1200 controls the non-volatile memory device 1100 to copy data stored in the remaining memory blocks, excluding the invalid memory block BLK_INV and the additional invalid memory block BLK_INV_ADD, among the plurality of memory blocks to other memory blocks while performing a wear leveling or a read reclaim.

In an embodiment, the storage device 1000 may provide the unmap requirement request REQ_UM requesting provision of the unmap command CMD_UM to the host 2000 in response to the invalid area comparison command CMD_C, and the host 2000 may provide the unmap command CMD_UM to the storage device 1000 prior to write commands and read commands stored in the host queue 2300 based on the unmap requirement request REQ_UM. For example, the storage device 1000 provides unmap requirement request REQ_UM when the comparison results from the invalid area comparison command CMD_C indicates that the number of invalid host blocks significantly exceeds the number of invalid memory blocks by more than a predefined threshold. The host 2000 may then analyze the information in the unmap requirement request REQ_UM along with the comparison results from the invalid area comparison command CMD_C to determine whether to provide the unmap command CMD_UM before executing write and read commands stored in the host queue 2300.

In an embodiment, the storage device 1000 sets non-invalidated memory blocks as the additional invalidated memory blocks BLK_INV_ADD based on the unmap command CMD_UM received prior to write commands and read commands stored in the host queue 2300, thereby preventing data stored in the non-invalidated memory blocks from being copied to other memory blocks and increasing the WAF while performing internal operations.

In an embodiment, the storage device 1000 erases data stored in non-invalidated memory blocks as well as invalidated memory blocks while performing the internal operations by setting non-invalidated memory blocks as the additional invalidated memory blocks BLK_INV_ADD based on the unmap command CMD_UM received prior to write commands and read commands stored in the host queue 2300.

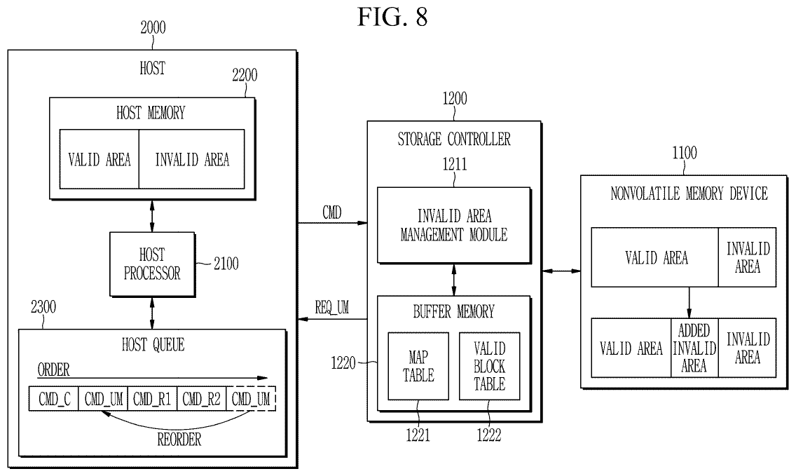

FIG. 8 is a drawing illustrating an electronic system for reordering an order of an unmap command and setting additional invalid areas based on a difference between invalid areas of a non-volatile memory device and invalid areas of a host according to an embodiment.

Referring to FIG. 8, each of the host memory 2200 and the non-volatile memory device 1100 may include valid area VALID AREA where valid data is stored and invalid area INVALID AREA where invalid data is stored.

In an embodiment, the host processor 2100 generates the invalid area comparison command CMD_C including invalid area information of the host memory 2200 and provides the invalid area comparison command CMD_C to the host queue 2300. In an embodiment, the invalid area information of the host memory 2200 includes information regarding a size of the invalid area INVALID AREA of the host memory 2200.

In an embodiment, the host queue 2300 stores a plurality of commands in an order of the invalid area comparison command CMD_C, the first read command CMD_R1, the second read command CMD_R2, and the unmap command CMD_UM.

In an embodiment, the host queue 2300 provides the invalid area comparison command CMD_C to the storage controller 1200.

In an embodiment, the invalid area management module 1211 generates invalid area information of the non-volatile memory device 1100 in response to the invalid area comparison command CMD_C. The invalid area information of the non-volatile memory device 1100 may include information regarding a size of the invalid area of the non-volatile memory device 1100.

In an embodiment, the invalid area management module 1211 compares the invalid area information of the host memory 2200 with the invalid area information of the non-volatile memory device 1100 in response to the invalid area comparison command CMD_C.

In an embodiment, the invalid area management module 1211 provides the request REQ_UM indicating whether the unmap command CMD_UM is necessary to the host 2000 as a response to the invalid area comparison command CMD_C based on a result of comparing the size of the invalid area INVALID AREA of the host memory 2200 with the size of the invalid area INVALID AREA of the non-volatile memory device 1100.

In an embodiment, when a difference in the size of an invalid area INVALID AREA of the host memory 2200 and the size of an invalid area INVALID AREA of the non-volatile memory device 1100 is greater than a threshold size, the invalid area management module 1211 provides the unmap requirement request REQ_UM indicating that the unmap command CMD_UM is required to the host 2000.

In an embodiment, when the difference in the size of the invalid area INVALID AREA of the host memory 2200 and the size of the invalid area INVALID AREA of the non-volatile memory device 1100 is greater than the threshold size, the invalid area management module 1211 determines a size of an area to be invalidated among the valid area VALID AREA of the non-volatile memory device 1100 based on the difference in the size of the invalid area INVALID AREA of the host memory 2200 and the size of the invalid area INVALID AREA of the non-volatile memory device 1100, and provides the unmap requirement request REQ_UM including information regarding the size of the area to be invalidated to the host 2000.

In an embodiment, the host processor 2100 receives the unmap requirement request REQ_UM and reorders the order in which the unmap command CMD_UM is provided to the storage controller 1200 based on the unmap requirement request REQ_UM.

In an embodiment, the host processor 2100 reorders the order of the unmap command CMD_UM to provide the unmap command CMD_UM to the storage controller 1200 prior to the first read command CMD_R1 and the second read command CMD_R2.

In an embodiment, the host queue 2300 reorders the order in which the plurality of commands are stored into the order of the unmap command CMD_UM, the first read command CMD_R1, and the second read command CMD_R2, and provides the unmap command CMD_UM to the storage controller 1200.

In an embodiment, the unmap command CMD_UM includes information regarding invalid logical addresses corresponding to some invalid area among the invalid area INVALID AREA of the host memory 2200.

In an embodiment, the invalid area management module 1211 receives the unmap command CMD_UM and, in response to the unmap command CMD_UM, unmaps the invalid logical addresses and physical addresses corresponding to the invalid logical addresses.

In an embodiment, the invalid area management module 1211 sets an area corresponding to the invalid logical addresses among the valid area VALID AREA of the non-volatile memory device 1100 as an additional invalid area ADDED INVALID AREA in response to the unmap command CMD_UM.

In an embodiment, when the difference in the size of the invalid area INVALID AREA of the host memory 2200 and the size of the invalid area INVALID AREA of the non-volatile memory device 1100 is less than the threshold size, the invalid area management module 1211 provides the unmap unnecessary request REQ_UM indicating that the unmap command CMD_UM is unnecessary to the host 2000.

In an embodiment, the host processor 2100 does not reorder the order in which the unmap command CMD_UM is provided to the storage controller 1200 when the unmap unnecessary request REQ_UM is received.

In an embodiment, the host processor 2100 controls the host queue 2300 to provide the first read command CMD_R1 and the second read command CMD_R2 to the storage controller 1200 prior to the unmap command CMD_UM when the unmap unnecessary request REQ_UM is received indicating that an unmap operation is not required. In this case, the host processor 2100 does not reorder the unmap command CMD_UM and prioritizes read commands before executing the unmap operation.

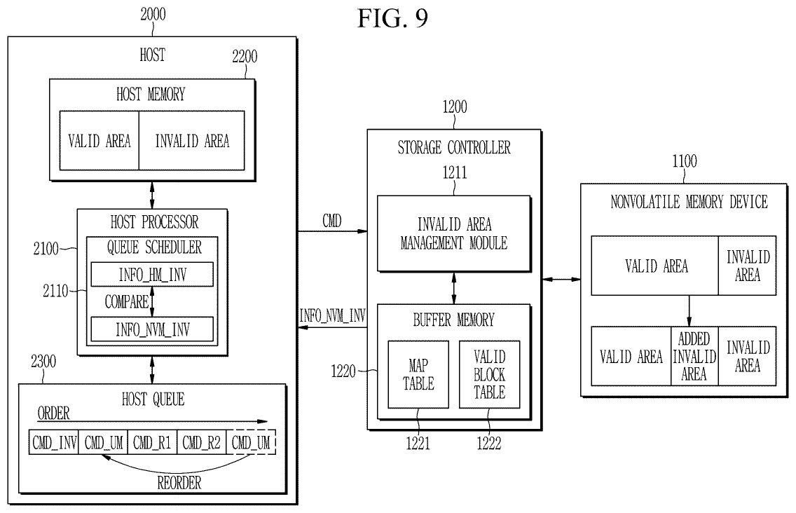

FIG. 9 is a drawing illustrating a host that reorders an order of unmap commands based on a result of comparing an invalid area of a non-volatile memory device with an invalid area of the host according to an embodiment.

Referring to FIG. 9, the host processor 2100 may generate an invalid area information request command CMD_INV and provide the invalid area information request command CMD_INV to the host queue 2300. In an embodiment, the invalid area information request command CMD_INV is a command requesting information regarding the invalid area INVALID AREA of a non-volatile memory device 1100.

In an embodiment, the host queue 2300 stores a plurality of commands in an order of the invalid area information request commands CMD_INV, the first read command CMD_R1, the second read command CMD_R2, and the unmap command CMD_UM.

In an embodiment, the host queue 2300 provides the plurality of commands to the storage controller 1200 in the order of the invalid area information command CMD_INV, the first read command CMD_R1, the second read command CMD_R2, and the unmap command CMD_UM, when the order of the plurality of commands is not reordered.

In an embodiment, the invalid area management module 1211 generates invalid area information INFO_NVM_INV of the non-volatile memory device 1100 in response to the invalid area information request command CMD_INV.

In an embodiment, the invalid area information INFO_NVM_INV of the non-volatile memory device 1100 includes information regarding the size of the invalid area INVALIDE AREA of the non-volatile memory device 1100 or the number of invalid memory blocks (BLK_INV of FIG. 5) of the non-volatile memory device 1100.

In an embodiment, the invalid area management module 1211 provides the invalid area information INFO_NVM_INV of the non-volatile memory device 1100 to the host 2000 in response to the invalid area information request command CMD_INV.

In an embodiment, the host processor 2100 includes a queue scheduler 2110. For example, the queue scheduler 2110 may be a logic circuit or a program executed by the host processor 2100.

In an embodiment, the queue scheduler 2110 receives the invalid area information INFO_NVM_INV of the non-volatile memory device 1100 and generates invalid area information INFO_HM_INV of the host memory 2200. The invalid area information INFO_HM_INV of the host memory 2200 may include information regarding the size of the invalid area INVALID AREA of the host memory 2200 or the number of invalid host blocks (HB_INV of FIG. 5) of the host memory 2200.

In an embodiment, the queue scheduler 2110 reorders the order in which the unmap command CMD_UM is provided to the storage controller 1200 based on a result of comparing the invalid area information INFO_HM_INV of the host memory 2200 and the invalid area information INFO_NVM_INV of the non-volatile memory device 1100.

In an embodiment, the queue scheduler 2110 reorders the order of the unmap command CMD_UM to provide the unmap command CMD_UM to the storage controller 1200 prior to the first read command CMD_R1 and the second read command CMD_R2 when a difference in the size of the invalid area INVALID AREA of the host memory 2200 and the size of the invalid area INVALID AREA of the non-volatile memory device 1100 is greater than the threshold size.

In an embodiment, when the difference in the size of an invalid area INVALID AREA of the host memory 2200 and the size of the invalid area INVALID AREA of the non-volatile memory device 1100 is greater than the threshold size, the queue scheduler 2110 controls the host queue 2300 to provide the plurality of commands to the storage controller 1200 in the order of the unmap command CMD_UM, the first read command CMD_R1, and the second read command CMD_R2.

In an embodiment, in response to the unmap command CMD_UM received prior to the first read command CMD_R1 and the second read command CMD_R2, the invalid area management module 1211 unmaps invalid logical addresses corresponding to some areas of the invalid area INVALID AREA of the host memory 2200 and physical addresses corresponding to the invalid logical addresses.

In an embodiment, in response to the unmap command CMD_UM, the invalid area management module 1211 sets an area corresponding to the invalid logical addresses among the valid areas VALID AREA of the non-volatile memory device 1100 as the additional invalid area ADDED INVALID AREA.

In an embodiment, the queue scheduler 2110 does not reorder the order of the unmap command CMD_UM when the difference between the size of the invalid area INVALID AREA of the host memory 2200 and the size of the invalid area INVALID AREA of the non-volatile memory device 1100 is less than the threshold size.

In an embodiment, the queue scheduler 2110 controls the host queue 2300 to provide the plurality of commands to the storage controller 1200 in the order of the first read command CMD_R1, a second read command CMD_R2, and the unmap command CMD_UM when the difference in the size of the invalid area INVALID AREA of the host memory 2200 and the size of the invalid area INVALID AREA of the non-volatile memory device 1100 is less than the threshold size.

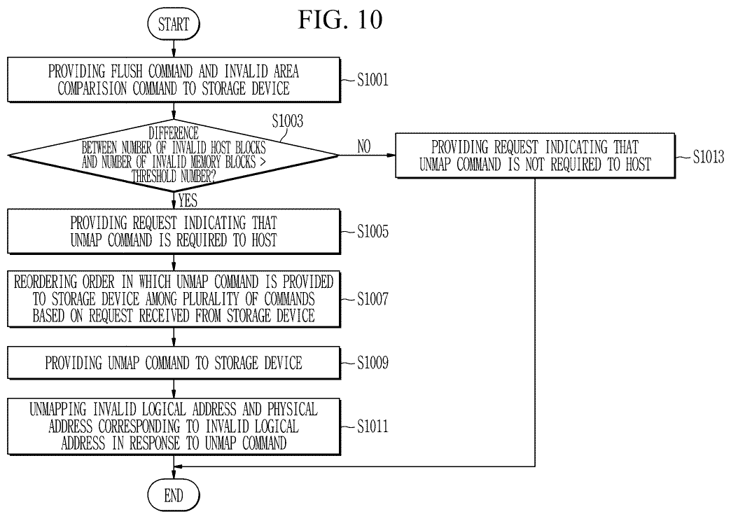

FIG. 10 is a flowchart illustrating an operation of an electronic system according to an embodiment.

Referring to FIG. 10, in S1001, the host 2000 may provide the flush command and the invalid area comparison command to the storage device 1000.

In an embodiment, the host 2000 may provide the invalid area compare command to the storage device 1000 when providing the flush command to the storage device 1000. In an embodiment, the flush command is provided before the invalid area comparison command to ensure that all pending write operations have been committed before any further memory management operations occur. The prior flushing may ensure data integrity.

In S1003, the storage device 1000 compares the difference between the number of invalid host blocks and the number of invalid memory blocks with the threshold number in response to the invalid area comparison command. In an embodiment, the invalid host blocks are host blocks in which invalid data is stored among the plurality of host blocks of the host memory 2200. In an embodiment, the invalid memory blocks are memory blocks in which invalid data is stored among the plurality of memory blocks of the non-volatile memory device 1100. In an embodiment, S1005 is performed when the difference between the number of invalid host blocks and the number of invalid memory blocks is greater than the threshold number. In an embodiment, S1013 is performed when the difference between the number of invalid host blocks and the number of invalid memory blocks is less than the threshold number.

In S1005, the storage device 1000 provides a request to the host 2000 indicating that the unmap command is required when the difference between the number of invalid host blocks and the number of invalid memory blocks is greater than the threshold number.

In an embodiment, the storage device 1000 determines the number of memory blocks to be invalidated among the valid memory blocks of the non-volatile memory device 1100 based on the difference between the number of invalid host blocks and the number of invalid memory blocks and the difference between the threshold number, and may provide the request including information regarding the number of memory blocks to be invalidated to the host 2000.

In S1007, the host 2000 reorders the order in which the unmap command is provided to the storage device 1000 among the plurality of commands based on the request received from the storage device 1000. In an embodiment, the host 2000 reorders the unmap commands to provide the unmap command to the storage device 1000 prior to the remaining commands among the plurality of commands based on the request indicating that the unmap command is required.

In S1009, the host 2000 provides the unmap command to the storage device 1000.

In S1011, the storage device 1000 unmaps an invalid logical address and a physical address corresponding to the invalid logical address in response to the unmap command. In an embodiment, the invalid logical address is an address corresponding to an invalid host block among the plurality of host blocks of the host memory 2200. In an embodiment, the storage device 1000 sets a memory block corresponding to the invalid logical address among valid memory blocks of the non-volatile memory device 1100 as an invalid memory block in response to the unmap command.

In S1013, the storage device 1000 provides the request to the host 2000 indicating that the unmap command is unnecessary when the difference between the number of invalid host blocks and the number of invalid memory blocks is less than the threshold number. In an embodiment, the host 2000 provides the remaining commands among the plurality of commands to the storage device 1000 prior to the unmap command based on the request indicating that the unmap command is unnecessary.

According to an embodiment, a storage device comprises a non-volatile memory 1100 and a storage controller 1200 configured to receive a comparison command CMD_C from a host 2000 and, in response, compare invalid block information associated with memory of the host 2000 and the non-volatile memory 1100 to generate a comparison result. The storage controller 1200 is further configured to, in response to generating the comparison result, determine whether an unmap operation is required based on a threshold and, if required, provide an unmap request REQ_UM to the host 2000. The storage controller 1200 is further configured to, in response to providing the unmap request REQ_UM, receive an unmap command CMD_UM from the host 2000 and, in response, update mapping information to unmap specified addresses. The storage controller 1200 is further configured to, in response to unmapping the addresses, update the status of corresponding memory blocks in the non-volatile memory 1100.

The comparison command CMD_C may be an invalid area comparison command issued by the host processor 2100. The comparison result may be based on a difference between invalid block counts in a memory of the host 2000 and the non-volatile memory 1100. The storage controller 1200 may determine that an unmap operation is required when the difference between invalid block counts exceeds a predefined threshold. The unmap request REQ_UM may be provided by the storage controller 1200 to the host processor 2100. The host processor 2100 may determine whether to provide the unmap command CMD_UM based on the unmap request REQ_UM and the comparison result. The mapping information updated in response to the unmap command CMD_UM may be stored in a map table 1221. The storage controller 1200, in response to unmapping the addresses, may mark the corresponding memory blocks as invalid in a valid block table 1222.

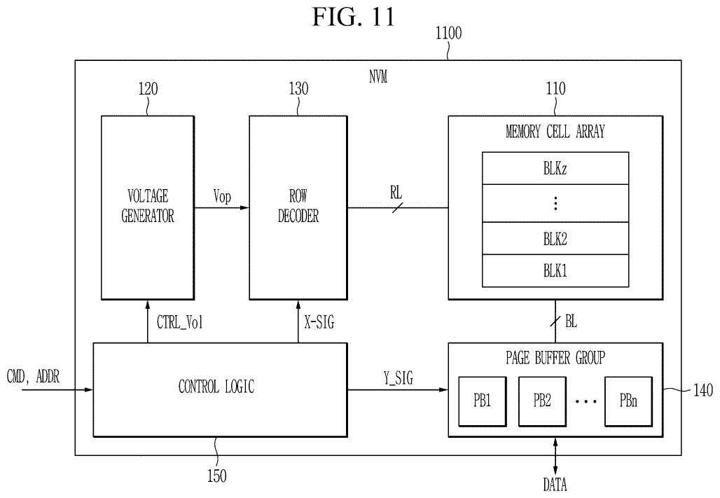

FIG. 11 is a drawing for illustrating a non-volatile memory device according to an embodiment.

Referring to FIG. 11, the non-volatile memory device 1100 may include a memory cell array 110, a voltage generator 120, a row decoder 130, a page buffer group 140, and control logic 150.

The memory cell array 110 may include the plurality of memory blocks BLK1 to BLKz. The plurality of memory blocks BLK1 to BLKz may be connected to the row decoder 130 through row lines RL. The plurality of memory blocks BLK1 to BLKz may be connected to the page buffer group 140 through bit lines BL. Each of the plurality of memory blocks BLK1 to BLKz may include a plurality of memory cells. In an embodiment, the plurality of memory cells may be non-volatile memory cells.

In an embodiment, the plurality of memory blocks BLK1 to BLKz may include invalid memory blocks containing invalid data and valid memory blocks containing valid data.

The voltage generator 120 may generate operating voltages Vop using an external power voltage supplied to the non-volatile memory device 1100. The voltage generator 120 may operate in response to the control of the control logic 150. In an embodiment, the voltage generator 120 may generate the operating voltages Vop used for the program operation, the read operation, and the erase operation. In an embodiment, the voltage generator 120 may generate a program voltage, a pass voltage, a read voltage, and an erase voltage. The operating voltages Vop may be supplied to the memory cell array 110 by the row decoder 130.

The row decoder 130 may be connected to the memory cell array 110 via the row lines RL. The row lines RL may include string select lines, word lines, and ground select lines. The row decoder 130 may operate in response to the control of the control logic 150.

The row decoder 130 may receive a row signal X_SIG from the control logic 150. In an embodiment, the row decoder 130 may select at least one word line among a plurality of word lines based on the row signal X_SIG and apply the operating voltages Vop provided from the voltage generator 120 to at least one word line.

In an embodiment, the row decoder 130 may apply the program voltage to a selected word line among the plurality of word lines during the program operation and apply the pass voltage at a level lower than the program voltage to unselected word lines.

The row decoder 130 may apply a verification voltage to the selected word line and apply a verification pass voltage at a level higher than the verification voltage to the unselected word lines during a program verification operation.

The row decoder 130 may apply the read voltage to the selected word line and apply a read pass voltage at a level higher than the read voltage to the unselected word lines during the read operation.

A page buffer group 140 may include a plurality of page buffers PB1 to PBn. The plurality of page buffers PB1 to PBn may be respectively connected to the plurality of memory cells included in the memory cell array 110 through the bit lines BL. The plurality of page buffers PB1 to PBn may operate in response to the control of the control logic 150.

In an embodiment, the plurality of page buffers PB1 to PBn may receive data DATA from the storage controller 1200. The plurality of page buffers PB1 to PBn may select at least one bit line among the bit lines BL based on a column signal Y_SIG received from the control logic 150.

In an embodiment, the plurality of page buffers PB1 to PBn may transmit data DATA received from a storage controller 1200 to the plurality of memory cells of the memory cell array 110 through the bit lines BL during the program operation. The plurality of memory cells may be programmed according to received data DATA.

The plurality of page buffers PB1 to PBn may sense data stored in the plurality of memory cells through the bit lines BL during the program verification operation.

The plurality of page buffers PB1 to PBn may sense data stored in memory cells through the bit lines BL during the read operation and store the sensed data in the plurality of page buffers PB1 to PBn.

The control logic 150 may be connected to the voltage generator 120, the row decoder 130, and the page buffer group 140. The control logic 150 may control the overall operation of the non-volatile memory device 1100.

The control logic 150 may control the voltage generator 120, the row decoder 130, and the page buffer group 140 to perform an operation corresponding to the command CMD in response to the command CMD received from the storage controller 1200.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

What is claimed is:

1. An electronic system comprising:
a host configured to output an invalid area comparison command including invalid block information indicating a number of invalid host blocks containing invalid data among a plurality of host blocks included in a host memory; and
a storage device, in response to the invalid area comparison command, configured to provide a request to the host indicating whether an unmap command provided by the host is necessary based on a result of comparing a number of invalid memory blocks containing invalid data among a plurality of memory blocks included in a non-volatile memory device and the number of invalid host blocks.

2. The electronic system of claim 1,
wherein the storage device is configured to provide an unmap requirement request indicating necessity of the unmap command to the host as the request when a difference between the number of the invalid host blocks and the number of the invalid memory blocks is greater than a threshold number.

3. The electronic system of claim 2,
wherein the storage device is configured to provide the unmap requirement request including information indicating a number of memory blocks to be invalidated among the plurality of memory blocks in the unmap requirement request to the host.

4. The electronic system of claim 3,
wherein the storage device is configured to determine the number of memory blocks to be invalidated based on the difference between the number of invalid host blocks and the number of invalid memory blocks.

5. The electronic system of claim 2, wherein the host comprises:
a host queue configured to store a plurality of commands including the unmap command; and
a host processor configured to reorder an order in which the unmap command among the plurality of commands is provided to the storage device based on the unmap requirement request.

6. The electronic system of claim 5,
wherein the host queue is configured to provide the unmap command including invalid logical addresses corresponding to the invalid host blocks to the storage device prior to remaining commands among the plurality of commands, based on the unmap requirement request.

7. The electronic system of claim 6,
wherein the host processor is configured to determine a number of invalid logical addresses included in the unmap command based on information indicating a number of memory blocks to be invalidated included in the unmap requirement request.

8. The electronic system of claim 6,
wherein the storage device, in response to the unmap command, is configured to unmap the invalid logical addresses and physical addresses corresponding to the invalid logical addresses, and set memory blocks corresponding to the invalid logical addresses among the plurality of memory blocks as invalid memory blocks.

9. The electronic system of claim 1,
wherein the storage device is configured to provide an unmap unnecessary request indicating unnecessity of the unmap command to the host as the request when a difference between the number of the invalid host blocks and the number of the invalid memory blocks is less than a threshold number.

10. The electronic system of claim 9, wherein the host comprises:
a host queue configured to store a plurality of commands including the unmap command; and
a host processor configured to control the host queue to provide remaining commands among the plurality of commands to the storage device prior to the unmap command based on the unmap unnecessary request.

11. The electronic system of claim 1,
wherein the storage device includes a buffer memory, and
wherein the host is configured to provide the invalid area comparison command to the storage device after providing a flush command to the storage device that stores data stored in the buffer memory to the non-volatile memory device.

12. A storage device comprising:
a non-volatile memory device including a valid area containing valid data and an invalid area containing invalid data; and
a storage controller configured to receive an invalid area comparison command including invalid area information indicating a size of an invalid area of a host, and provide a request to the host indicating whether an unmap command is necessary based on a result of comparing the size of the invalid area of the host and a size of the invalid area of the non-volatile memory device.

13. The storage device of claim 12,
wherein the storage controller is configured to provide an unmap requirement request indicating necessity of the unmap command to the host as the request when a difference between the size of the invalid area of the host and the size of the invalid area of the non-volatile memory device is greater than a threshold size.

14. The storage device of claim 13,
wherein the storage controller is configured to determine a size of an area to be invalidated among the valid areas of the non-volatile memory device based on the difference between the size of the invalid area of the host and the size of the invalid area of the non-volatile memory device, and provide the unmap requirement request including information indicating the size of the invalid area to be invalidated to the host.

15. The storage device of claim 13,
wherein the storage controller, after providing the unmap requirement request to the host, is configured to unmap invalid logical addresses included in the unmap command and physical addresses corresponding to the invalid logical addresses, and set an area corresponding to the invalid logical addresses among the valid areas of the non-volatile memory device as an invalid area in response to the unmap command received from the host.

16. The storage device of claim 12,
wherein the storage controller is configured to provide an unmap unnecessary request indicating unnecessity of the unmap command to the host as the request when a difference between the size of the invalid area of the host and the size of the invalid area of the non-volatile memory device is less than a threshold size.

17. A storage controller comprising:
a memory interface configured to communicate with a non-volatile memory device including valid blocks and invalid blocks;
a host interface configured to receive information indicating a number of invalid blocks of the host from the host; and
an invalid area management module configured to request the host to provide an unmap command based on a result of comparing the number of invalid blocks of the host and a number of invalid blocks of the non-volatile memory device.

18. The storage controller of claim 17,
wherein the invalid area management module is configured to provide information indicating a number of blocks to be invalidated among the valid blocks of the non-volatile memory device to the host when a difference between the number of the invalid blocks of the host and the number of the invalid blocks of the non-volatile memory device is greater than a threshold number.

19. The storage controller of claim 17,
wherein the invalid area management module, after requesting the host to provide the unmap command, is configured to set blocks corresponding to invalid logical addresses included in the unmap command among the valid blocks of the non-volatile memory device as additional invalid blocks in response to the unmap command received from the host.

20. The storage controller of claim 19,
wherein the invalid area management module is configured to control the non-volatile memory device to perform an operation to erase data stored in the invalid blocks and the additional invalid blocks of the non-volatile memory device.
